(19) United States
(12) Patent Application Publication
(10) Pub. No.: US 2002/0073389 A1
(43) Pub. Date: Jun. 13, 2002

(54) Clock tuning circuit in chip design

(76) Inventors: Yaron Elboim, Haifa (IL); Avinoam Kolodny, Haifa (IL); Ran Ginosar, Nofit (IL)

Correspondence Address: OLIFF & BERRIDGE, PLC, P.O. BOX 19928, ALEXANDRIA, VA, 22320, US

(21) Appl. No.: 09/734,715

(22) Filed: Dec. 13, 2000

(51) Int. Cl. G06F 17/50

(52) U.S. Cl. 716/6; 716/5

(57) ABSTRACT

A method system and apparatus for implementing clock delay insertion for modules of chips using programmable clock delay units are described. The system for adding a clock delay to the clock input of a module includes a module and a programmable clock delay unit pre-pended to the module and configured to add a programmed clock delay.

### FIELD AND BACKGROUND OF THE INVENTION

The present invention relates to a system, method and apparatus for clock alignment in chip design and, more particularly, to a system, method, and apparatus for clock alignment of a chip.

It should be understood that the term clock alignment as used hereinbelow does not necessarily imply zero clock skew but implies a clock skew which is small enough to allow proper functioning of the chip.

Chips are often classified by the number of transistors and other electronic components they contain. For example, SSI (small-scale integration): Up to 100 electronic components per chip; MSI (medium-scale integration): From 100 to 3,000 electronic components per chip; LSI (large-scale integration): From 3,000 to 100,000 electronic components per chip; VLSI (very large-scale integration): From 100,000 to 1,000,000 electronic components per chip, and ULSI (ultra large-scale integration): More than 1 million electronic components per chip. Nearly all modem chips employ VLSI or ULSI architecture.

A self contained group of components on a chip can be referred to as a module. Each module on a chip can have a different internal clock delay (as will be explained later). In general, the tree structure of the internal clock distribution network within a module is balanced so that the internal clock delay is the same to all memory elements within a module.

Systems on a chip (SoC) are a type of VLSI which includes a complete system (for example a cellular phone, personal computer, etc.) on a single chip. SoC design relies heavily on effective reuse of semiconductor intellectual property (IPs or IP cores). Therefore, in the context of SoCs, IPs can be considered as building block modules.

In chip design, a buffered clock distribution network is typically used to drive the large clock load. Chip design involves a clock alignment step, which equalizes the delay from the network root (clock distribution center) to each and every leaf (flip flops, latches, or other memory elements) in each and every module. Accurate clock alignment is important, because unwanted differences or uncertainties in clock network delays may degrade performance or cause functional errors. Clock distribution and alignment have become an increasingly challenging problem in chip design, consuming an increasing fraction of resources such as wiring, power and design time.

Chips are typically designed to be fully synchronous, but interconnect delays and gate delays in deep sub micron technology make these chips mesochronous (i.e. having the same frequency but different phases) because signals may be out of phase, with an arbitrary phase difference.

Throughout the description below, SoCs are used as a non-limiting example of an application for clock alignment. However, the invention applies equally to other types of chip design.

An example of the problem of clock alignment when merging IP cores into a single synchronized SoC is presented below, along with prior art solutions and the shortcomings of the prior art solutions.

Prior art FIG. 1 illustrates a first IP core (IP1) 20 and the assumed timing diagram of IP1 20. A required input 1 (required in1) 23 illustrates the constraints on an input 1 (in1) 22 in terms of setup time and hold time. The setup time 1 (tₛₑₜᵤₚ₁) 28 is the period during which input 1 22 should be ready prior to the rise of a clock (clk) 24. The hold time 1 (t_{holdt}) 30 is the period during which in1 22 should not change after the rise of clock 24. A contamination delay 1 (t_{cd1}) 32 is the period during which an output 1 (out1) 26 retains an old value or the earliest time for out1 26 to transition to a new value. Delay t_{cd1} 32 can also be explained as the minimum interval following a reference signal change (clk 24 or in1 22) during which the validity of previous output is guaranteed to remain intact and is closely related to the shortest path of the circuit of IP1 20. A propagation delay 1 (t_{pd1}) 34 is the latest time for a transition of out1 26 and is related to the longest path of the circuit of IP1 20. Generally setup times, hold times, contamination delays and propagation delays are disclosed.

An internal clock delay 1 parameter (t_{int—clk—dly1}) 36 describes the internal clock delay within IP1 20 from the clock input port of IP1 20 to all the memory elements in IP1 20. Delay t_{int—clk—dly1} 36 results from the tree structure of the internal clock distribution network inside IP1 20. In general, the internal clock delay parameter is not supplied by hard IP core providers. For IP1 20, t_{int—clk—dly1} 36 is assumed to be zero.

Prior art FIG. 2 illustrates a second IP core (IP2) 40 and the assumed timing diagram of IP2 40. Clk 24 is also used for IP2 40. A required input 2 (required in2) 43 illustrates the constraints on an input 2 (in2) 42 in terms of periods tₛₑₜᵤₚ₂ 46 and t_{hold2} 48. Periods t_{cd2} 50, and t_{pd2} 52 for an output 2 (out2) 44 of IP2 40 are also illustrated in prior art FIG. 2.

For IP2 40, a t_{int—clk—dly2} 54 is assumed to be 0.9. A non-zero internal clock delay is typical in deep sub-micron processes. Due to the large t_{int—clk—dly2} 54 tₛₑₜᵤₚ₂ 46 is negative. (Note that by convention setup times including tₛₑₜᵤₚ₂ 46 are measured with reference to the clock rise at the clock input port of IP2 40 rather than with reference to the clock rise at memory elements within IP2 40). Prior art FIG. 3, shows an example of a structure for IP2 40 which would cause a large t_{int—clk—dly2} 54. Delay t_{int—clk—dly2} 54 is caused by a clock distribution tree 62 within IP2 40 prior to reaching flip flop 64.

Prior art FIG. 4 illustrates how IP1 20 and IP2 40 may be connected into a single SoC 70. A bus (data₁₃ bus) 72 (assumed to be 100 bits) connects out1 26 to in2 42. Clk 24 feeds both IP1 20 and IP2 40. For simplicity, it is assumed that there are no delays at the system level, on the clock distribution network which is external to IPs 20 and 40 and on data₁₃ bus 72.

Prior art FIG. 5 illustrates the combined timing diagram of SoC 70. A hold time violation for in2 42 is revealed. By convention, IP2 40 needs to sample input A 74 rather than input B 76. However, input A 74 is not held sufficiently long to fulfill hold time requirements t_{hold2} 48. The period in which in2 42 is required to be valid (i.e. remain constant and unchanged) is shown in FIG. 5 as a period 78.

From FIG. 5, it can be easily seen that IP1 20 is faster than IP2 40. Signal out1 26 is available before IP2 40 is ready to receive the signal.

There are two prior art solutions, commonly used to solve the problem of differing IP core speeds.

The first solution is known as the data delay insertion method, used for example in synthesizers. Refer to prior art FIG. 6. Delays are inserted on data_bus 72 in order to remove any setup or hold time violations. Continuing with the same example, a 0.3 nanoseconds (ns) delay (0.3 ns=t_{hold2}−t_{pd1}) would be added to each of the 100 lines of data_bus 72 resulting in e.g. 400 added inverters 80. The data delay insertion method is expensive in terms of area and power.

The second solution as shown in prior art FIG. 7 is to align clk 24 so as to turn SoC 70 into an SoC 81 with a clock aligned system (i.e. that memory elements within IP1 20 and within IP2 40 are aligned with each other). This method is referred to as the clock delay insertion method. Continuing with the same example, assuming t_{int—clk—dly2} 54 is 0.9 ns, if an external delay 86 of 0.9 ns is added to the clock signal of IP1 20, a new timing relationship between IP cores 20 and 40 will result.

Prior art FIG. 8 illustrates the new timing diagram for IP1 20 using the clock delay insertion method of FIG. 7. Prior art FIG. 9 illustrates the new combined timing diagram for SoC 81, using the clock delay insertion method of FIG. 7.

A clock reference point 82 before external delay 86 is the new reference point rather than a clock reference point 84 (at the clock port of IP1 20). Due to external delay 86, the old value of an output 1 (out1) 88 is retained longer with reference to new clk reference 82 in comparison with the retention of the old value of out1 26 with reference to clk 24 of FIG. 1. In other words, periods t_{cd1} 98 and t_{pd1} 100 are extended compared to t_{cd1} 32 and t_{pd1} 34 of FIG. 1. The old value of an input 2 (in2) 90 is therefore also retained longer with reference to clk 82 in comparison with the retention of the old value of in2 42 with reference to clk 24 of FIG. 5. As external delay 86 is not added to the clock reaching IP2 40 there is now no violation of holding time t_{hold2} 48. The extension of the old value of in2 90 is sufficient to meet holding time requirements t_{hold2} 48 as illustrated by required in2 43 timing diagram. The old value of in2 90 is retained during required valid period 78.

In typical designs, delay 86 has to be added manually between the clock distribution network and the clock port of IP core 20.

Refer to prior art FIG. 10a which shows a typical clock distribution network 120 for a chip. Distribution network 120 is structured as a tree in which all leaves are aligned and connected to the clock ports of all IP cores 124. Network 120 is balanced and the clock inputs of all different IP cores 124 receive the same clock phase 126.

The design of network 120 is complicated because network 120 must be balanced, and as discussed above may require the data delay insertion method for correct operation of the complete SoC.

Due to the clock distribution system which is external to the modules of the chip, the clock signals arriving at the clock input ports of different modules within a chip may have the same frequency but different phases. This type of clock distribution system is termed unbalanced.

Prior art FIG. 10b illustrates a clock distribution network 127 which utilizes the clock delay insertion method, causing clock distribution system 127 to become unbalanced. A different clock delay 128 can be provided to the clock input port of each IP core 124. These delays 128 compensate for the different internal clock delays of each IP core 124, allowing the complete chip to be clock aligned at a point 130, with each leaf (for example, flip flop, latch, or other memory element) having the same clock phase. It is important to note that a chip is considered clock aligned if each leaf (point 130) has substantially the same clock phase (subject to a small enough clock skew), even if the clock phase varies at the clock input ports of different IP cores 124 (i.e. even if clock distribution system 127 is unbalanced).

The prior art clock insertion method is traditionally based on the following design flow (assuming no delays on the clock distribution network external to the IPs—i.e. a balanced network):

1. Check each IP core for the internal clock delay dᵢ of the IP core

2. Find the maximal internal clock delay among all IP cores D=max (d₁)

3. Add delay Δᵢ=D-dᵢ for each IP core i.

The result of the method is that all clocks to internal memory elements are aligned.

Knowledge of internal clock delays are needed for the clock delay insertion method. For soft IP cores (high level defined IPs in the stage before translation into transistors), the delays can be computed by the designer. For hard IP cores (IPs that have already been translated into transistors), it would be convenient if the internal clock delays were provided by the hard IP core provider. Otherwise the internal clock delays can be calculated, for example, by simulation.

Ideally, IPs should be treated as “black boxes” to support “plug and play” such that IPs can be inserted or removed without affecting other blocks. However, the clock distribution network does not support this concept because each change influences the complete system. Theoretically, when designing a global clock distribution network, changes in a single IP core should not affect other parts of the network. But in practice, changing an IP core might change its layout, wire capacitances, resistance, floor plan, etc. Such changes may affect the physical design of the complete clock distribution network. This phenomenon can be described as “back propagation”. Redesign or re-verification of the global clock distribution network is required after each change. Such iterations are undesirable and should be minimized. For soft IP cores, clock tree routing is done during chip level integration. The clock distribution and alignment within the IP core becomes the responsibility of the system integrator. For hard IP cores, the clock routing is done during the IP core design. The timing interface between the hard IP core and the rest of the SoC (for example signal setup and hold times, input capacitance) must be carefully considered. Change of hard IP core might demand a complete redesign of the clock network. The same problem exists with soft IP cores which were already placed and engineers are reluctant to redesign them.

The prior art clock delay insertion method traditionally involves the following stages:

1. Adding delay elements to the relevant paths according to the design flow described above

2. Model extraction of the clock distribution network of each block and of the global clock network

3. Timing verification of all clock delays and design iteration if required.

The process is repeated whenever any of the system parts is changed. Therefore changes to the system will not be easily accepted. This global clock redesign is far from the “plug and play” concept desirable for modular design.

Some typical clock distribution architectures, such as delay matched serpentines and symmetric trees complicate the application of clock insertion. Global redesign of such clock networks incurs significant changes of the network at the cost of a heavy engineering effort even for small changes.

In large systems, clock delay tuning circuits are used in printed circuit boards (PCBs) to allow clock delay insertion without global clock redesign. High-speed systems with multiple printed boards for large systems often require clock tuning after assembly. A tuning circuit can be used statically or dynamically to perform clock alignment according to the uncertainty of the system. Multiple PLLs (Phase Lock Loop) may be employed to align the clock dynamically but are expensive and difficult to design. PLLs may also be employed in front of chips on printed boards to align the clock reaching the chip clock input port.

Conventional systems using printed boards do not generally require clock tuning systems. Conventional printed boards generally have lower frequencies than chips (approximately 10x lower) and therefore can tolerate a larger clock skew. (Allowable clock skew is usually expressed as a percentage of period time (i.e. 1/frequency) so if the frequency is lower, allowable clock skew can be higher) The design and implementation of clock tuning in printed boards can be found in William J. Dally and John W. Poulton, Digital Systems Engineering, Cambridge university press, 1998 Chapter 10 or in Kenneth D. Wagner, “Clock System Design”, IEEE Design Test Comput., pp9-27, October 1988, reprinted in E. Friedman, Clock Distribution Network in VLSI Circuits and Systems, New York: IEEE Press, 1995. Both of these sources are incorporated by reference.

The clock tuning methodology used in printed boards for large systems is not directly transferable to chip design. In printed boards for large systems, the clock tuning is performed after fabrication, because due to the manufacturing process, printed circuit boards in very large systems may differ from one another, and therefore each printed board needs to be tuned separately. In chips, it is preferable to perform tuning at least also before fabrication because if a clock problem is found in the fabricated chip, it generally implies problems with other signals and not just a manufacturing variation. In addition, in mass production of chips (or even conventional PCBs) it is impossible to tune millions of chips (or conventional PCBs) after the fabrication process. In large system printed boards, the tuning is performed in a hierarchical structure (i.e. down the clock distribution tree from clock source towards clock destination), because it is more convenient, whereas in chip design, hierarchical tuning is often unnecessary.

It is an object of the invention to provide an alternative method and system for implementing clock delay insertion in chips.

It is yet another object of the present invention to provide a method and system for implementing clock delay insertion in chips which eliminates the need for global clock redesign.

It is yet another object of the present invention to provide a method and system for implementing clock delay insertion in chips that allows a reduced number of clock distribution network design iterations compared to global clock redesign.

It is yet another object of the present invention to provide a clock tuning apparatus for use in chip design.

It is yet another object of the present invention to provide a clock tuning apparatus which allows an improved delay range.

It is yet another object of the present invention to provide for different methods of programming delays according to chip requirements.

### SUMMARY OF THE INVENTION

According to the present invention there is provided a method for adding a clock delay to the clock input of a module, including the steps of: deciding upon a minimum programmable clock delay for the module; and pre-pending a clock delay unit with a programmable clock delay to the module, wherein the programmable clock delay is configured to range up from the minimum programmable clock delay.

According to further features in preferred embodiments of the invention described below, the method further includes the step of: deciding upon a maximum programmable clock delay for the module; wherein the programmable clock delay is configured to range from the minimum programmable delay up to the maximum programmable clock delay.

According to still further features in preferred embodiments of the invention described below, the method further includes the step of: deciding upon a clock delay resolution; wherein the programmable clock delay is configured to increase in range by steps equivalent to the clock delay resolution.

According to yet still further features in preferred embodiments of the invention described below, the method further includes the step of: programming the programmable clock delay so as to give a desired programmed clock delay. Preferably, the module is included in a chip with at least one other module and wherein there exists differing delays between the module and at least one of the other modules, the programming step includes: adjusting for differing delays between the module and at least one of the other modules. In certain preferred embodiments, the adjusting step includes calculating a programmed clock delay, the calculated programmed clock delay substantially equaling the minimum programmable clock delay plus the maximum delay among all modules within the chip less the delay for the module. The differing delays can include internal and/or external delays.

In preferred embodiments where the programmable clock delay is configured to increase in steps, the adjusting step further includes: rounding the calculated programmed clock to the nearest programmable clock delay step.

In certain preferred embodiments, wherein the module is included in a chip, the programming step can be carried out during the final design stages of the chip. Alternatively, or in addition to, when the module is included in a chip, the programming step can be carried out during power up of the chip. Alternatively, or in addition to, the programming step can be carried out dynamically. Alternatively, or in addition to, wherein the module is included in a chip with at least one other module and the module and the at least one other module forming at least two subsystems and the at least two subsystems forming a system, the programming step can include programming the subsystems and the system hierarchically.

According to yet still further features in preferred embodiments of the invention described below, the method further includes the step of: repeating the step of programming as many times as required.

According to yet still further features in preferred embodiments of the invention described below, the module is included in a chip and the method further includes the step of: verifying that the programmed clock delay meets a timing constraint of the chip.

According to the present invention there is also provided, a system for adding a clock delay to the clock input of a module, including: a module; and a programmable clock delay unit pre-pended to the module, configured to add a programmed clock delay.

According to further features in preferred embodiments of the invention described below, the module is included in a chip and the system further includes: at least one other module within the chip, and the programmed clock delay adjusts for differing delays between the module and the at least one other module.

Preferably, the system also includes at least one other programmable clock delay unit pre-pended to at least one of the other modules. In certain preferred embodiments, at least one of the other programmable clock delay units pre-pended to at least one of the other modules is identical to the programmable clock delay unit pre-pended to the module.

According to still further features in preferred embodiments of the invention described below, the chip includes a system on a chip (SoC).

According to the present invention there is also provided an apparatus for programming a clock delay, including: at least one delay cell; and a delay control for selectively enabling the at least one delay cell.

According to further features in preferred embodiments of the invention described below, at least one of the delay cells includes at least one buffer.

According to still further features in preferred embodiments of the invention described below: at least one of the delay cells, when enabled, adds to a programmed clock delay by an amount substantially equivalent to the delay resolution of the apparatus.

According to yet still further features in preferred embodiments of the invention described below at least one of the delay cells, when enabled, adds to the programmed clock delay by an amount larger than the delay resolution of the apparatus. Preferably, the at least one delay cell actually includes at least two delay cells divided into at least two groups with differing delay resolutions, and the delay resolution of a group is at least substantially equal to the product of the next largest delay resolution and the number of delay cells within the group with the next largest delay resolution.

According to yet still further features in preferred embodiments of the invention described below: a programmed clock delay, when none of the at least one delay cells is enabled includes a parasitic delay. Alternatively, or in addition to, a programmed clock delay, when none of the at least one delay cells is enabled includes a delay due to at least one default buffer.

According to yet still further features in preferred embodiments of the invention described below: the delay control includes at least one control line and at least one multiplexer.

In certain preferred embodiments, the apparatus is a digital controlled tapped line.

In certain preferred embodiments, the apparatus is a static clock tuning unit.

### BRIEF DESCRIPTION OF THE DRAWINGS

The invention is herein described, by way of example only, with reference to the accompanying drawings, wherein:

FIG. 1 illustrates a prior art IP 1 and timing diagram for IP1;

FIG. 2 illustrates a prior art IP2 and timing diagram for IP2;

FIG. 3 illustrates a prior art structure for IP2;

FIG. 4 illustrates a prior art SoC including IP1 and IP2;

FIG. 5 illustrates a combined timing diagram for a prior art SoC;

FIG. 6 illustrates a prior art solution for IP1 and IP2 connectivity by data delay insertion method;

FIG. 7 illustrates a prior art solution for IP1 and IP2 connectivity by clock delay insertion method;

FIG. 8 illustrates a new timing diagram for IP1 using the prior art clock insertion method of FIG. 7;

FIG. 9 illustrates a new combined timing diagram for IP1 and IP2 using the prior art clock insertion method of FIG. 7;

FIG. 10a is a prior art typical clock distribution network;

FIG. 10b is a prior clock distribution network using the clock delay insertion method;

FIG. 11 is a clock delay insertion system using programmable clock delays, according to an embodiment of the current invention;

FIG. 12 is a block diagram of a basic delay unit of a clock tuning circuit with m=2, according to an embodiment of the current invention;

FIG. 13 is a table of the delay options of the basic delay unit of FIG. 12 with parasitic delay, according to an embodiment of the current invention;

FIG. 14 is a block diagram of a concatenation of basic delay units to form a clock tuning unit, according to an embodiment of the current invention;

FIG. 15 illustrates an example of the usage of a clock tuning unit, according to an embodiment of the current invention;

FIG. 16 is a schematic of a circuit for a clock tuning unit, according to an embodiment of the current invention;

FIG. 17 is a schematic of a skew fixer circuit, according to an embodiment of the current invention;

FIG. 18 is a schematic of a circuit of a multiplexer, according to an embodiment of the current invention;

FIG. 19 is a schematic of a circuit of a first basic delay unit, according to an embodiment of the current invention;

FIG. 20 is a schematic of a circuit of a delay cell of a first basic delay unit, according to an embodiment of the current invention;

FIG. 21 is a schematic of a circuit of a second basic delay unit, according to an embodiment of the current invention;

FIG. 22 is a schematic of a circuit of a delay cell of a second basic delay unit, according to an embodiment of the current invention.

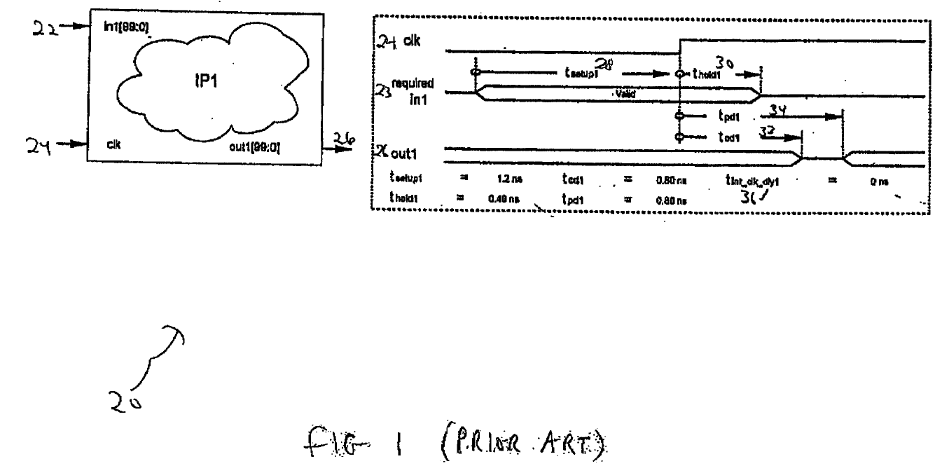

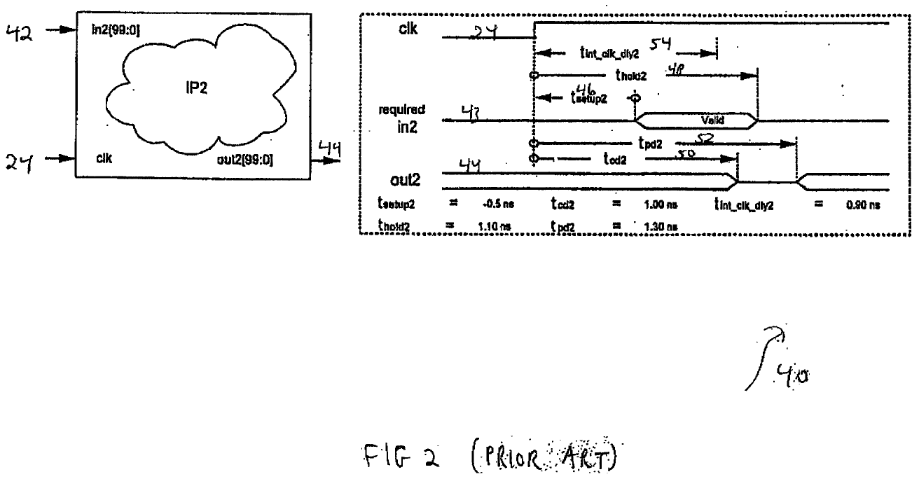

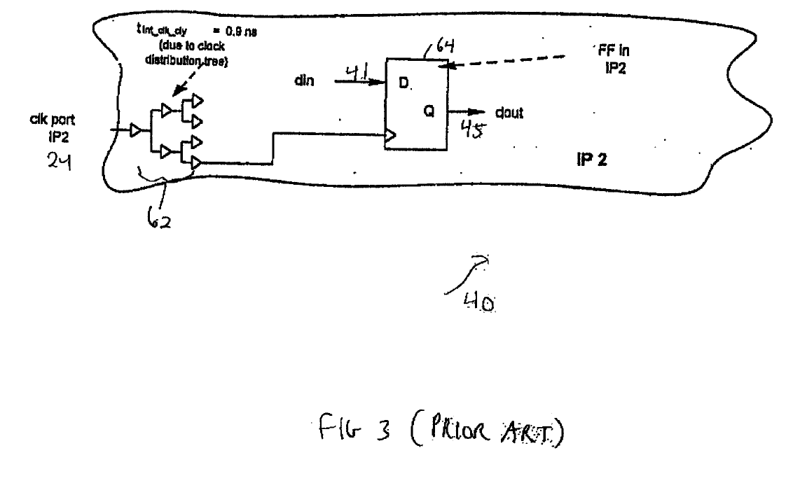

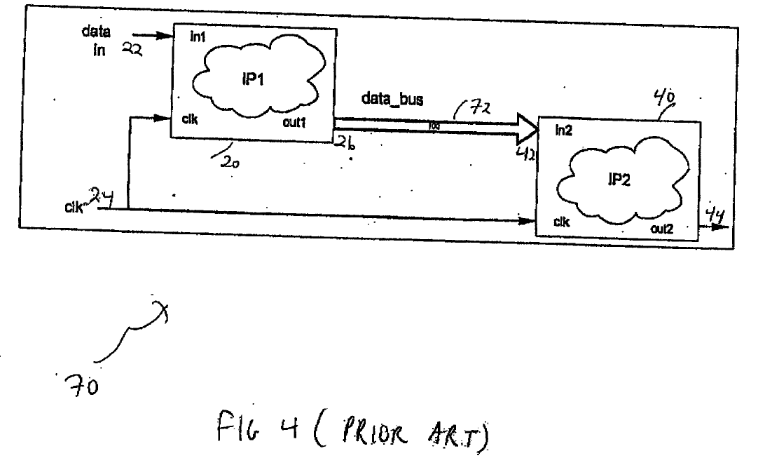

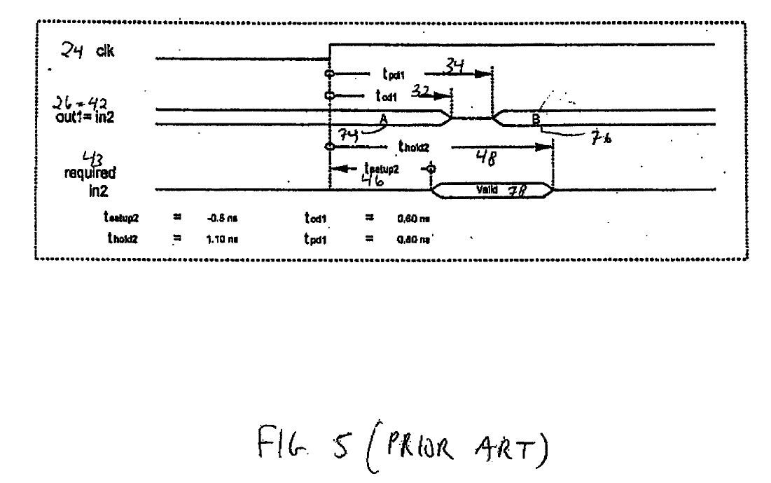

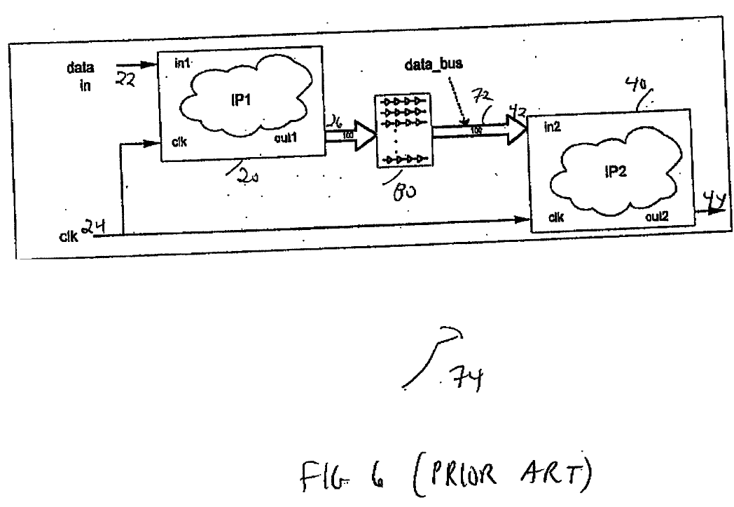

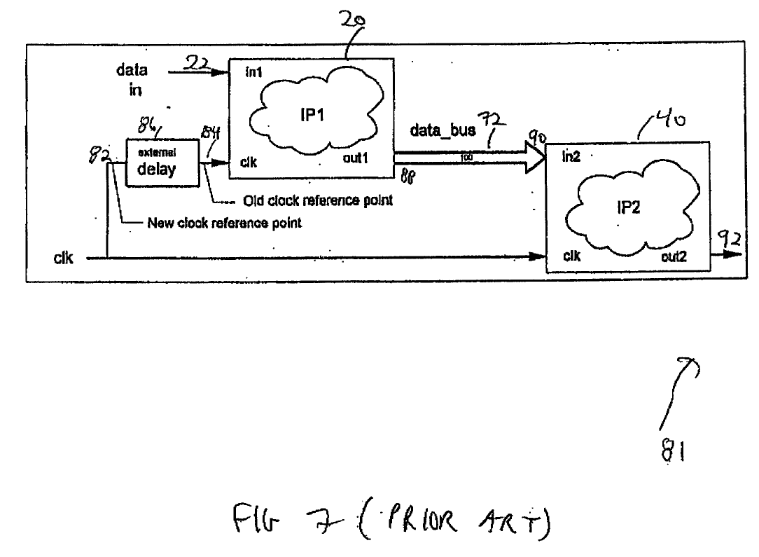

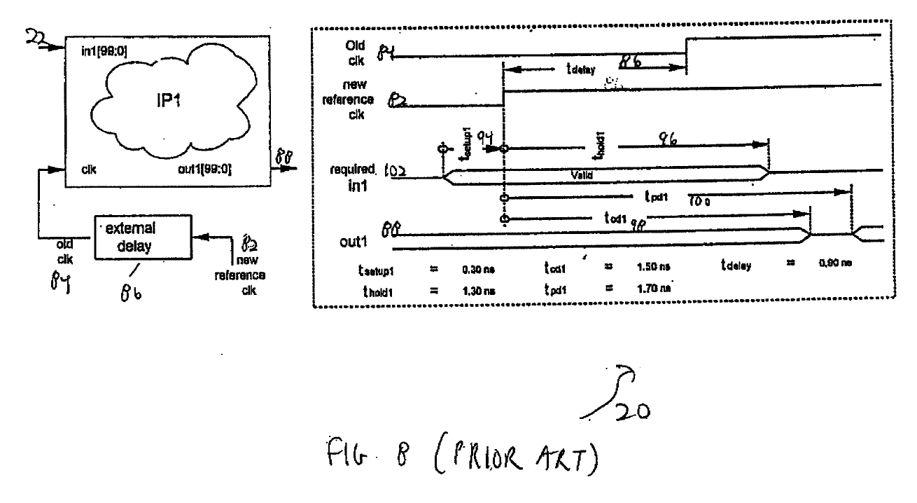

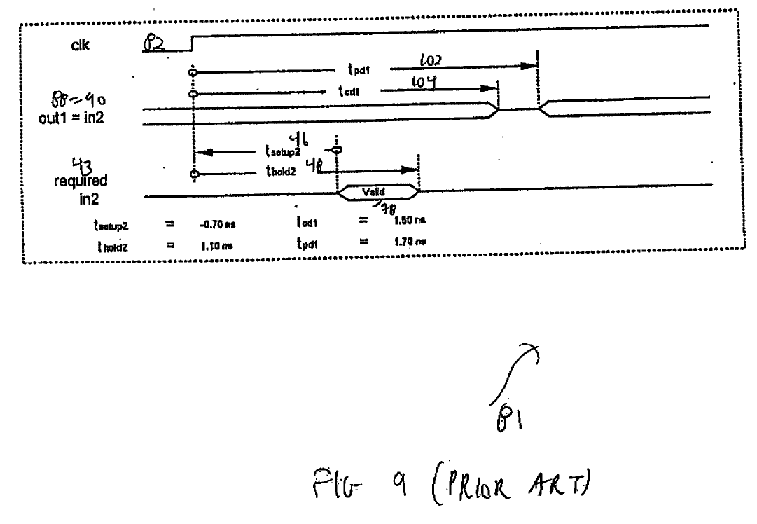

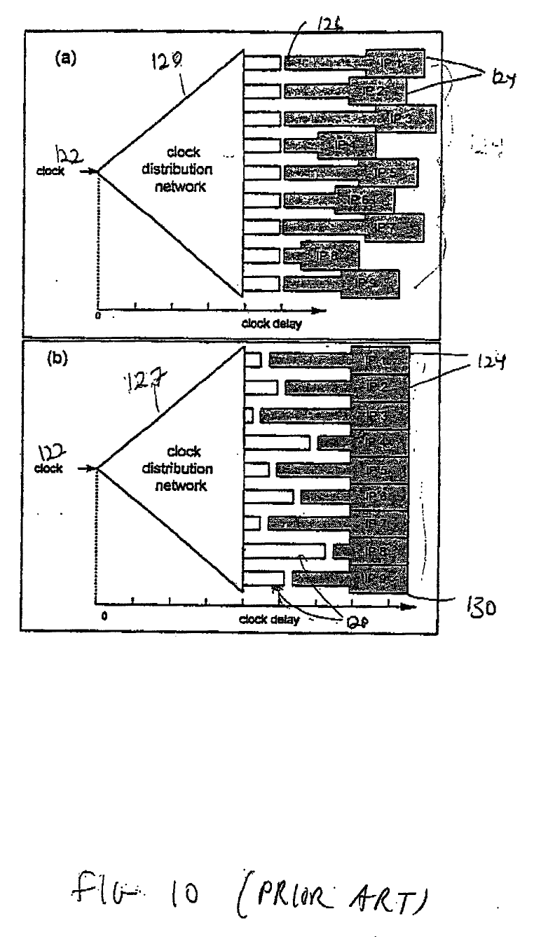

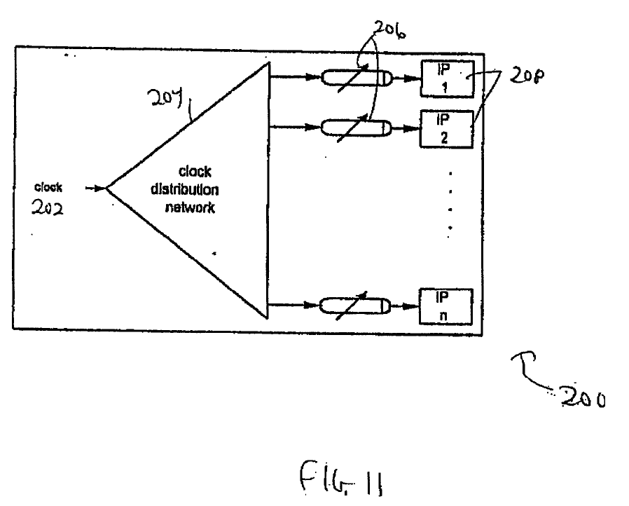

### DESCRIPTION OF THE PREFERRED EMBODIMENTS

The present invention is of a system, method and apparatus for clock tuning which can be used in chip design. Specifically, the present invention can be used to compensate for different internal and external clock delays of various modules, in a chip.

The principles and operation of a clock tuning system, method and apparatus according to the present invention may be better understood with reference to the drawings and the accompanying description.

Modules have different internal clock tree delays due to factors such as different sizes, form factors and different results of clock synthesis tools used for clock tree building. The external clock delays (i.e. from network root to clock input port of each module) may also differ, for example according to the locations of the modules across the die (silicon of the chip). In addition, external clock delays may differ if an unbalanced global clock distribution network is employed such that some modules get the clock signal earlier than others.

As mentioned above, SoCs composed of IP cores are used as a non-limiting example of an application for clock alignment. However, the invention applies equally to all other types of chip design.

Referring now to the drawings, FIG. 11 illustrates an SoC 200 which allows clock delay insertion using programmable clock delays. A clock distribution network 204 distributes a clock 202 to the clock port of each IP 208. A programmable clock delay unit 206 which allows the programming of clock delays is pre-pended (i.e. connected in front) to one or more IPs 208 of SoC 200. It should be evident that in the description hereinbelow, the term “pre-pended” includes both embodiments where delay unit 206 is connected in front of corresponding IP 208, as a distinguishable unit and external to IP 208, and embodiments where delay unit 206 is internal to corresponding IP 206 and connected in front of the rest of the circuit of IP 206.

In one embodiment of the invention, unit 206 pre-pended to one IP 208 may vary from unit 206 pre-pended to another IP 208 as long as certain constraints are met as will be described below. Unit 206 can compensate for internal and/or external clock delays.

In one embodiment of the invention, unit 206 is pre-pended to corresponding IP 208 only during the development of particular SoC 200. Preferably particular SoC 200 includes more than one IP 208 (module). In another embodiment of the invention, unit 206 is automatically pre-pended to corresponding IP 208 when IP 208 is developed, even with no particular SoC in mind.

In one embodiment of the invention, certain of IPs 208 within SoC 200 may not have programmable units 206 pre-pended and may use alternative solutions, if necessary, to compensate for internal and/or external clock delays.

In order to develop unit 206, one or both of the following parameters needs to be decided upon:

1. Minimum (or minimal) programmable delay for unit 206—this parameter describes the minimum amount of clock delay that can be programmed to be added by unit 206. Although the lower bound on the minimum is theoretically zero, in practice the lower bound is constrained by the existence of parasitic delays and/or default buffers included in the path. The minimum programmable delay can be higher than the lower bound, if a certain amount of delay is desired to be added in all situations, and different units 206 pre-pended to different IPs 208 may have different minimum programmable delays even if the necessary (constrained) lower bounds are identical.

It should be understood that in embodiments where a minimum amount of delay is added by units 206 (for example due to different parasitic delays, default buffers or other design considerations), units 206 will themselves cause (or add to) external clock delays for corresponding IPs 208. Therefore, the minimum delays of each unit 206 should be included within the total external clock delay for corresponding IP 208 when calculating the lower bounds on maximal programmable delays as described below. Alternatively, in other embodiments, the minimum delay of each unit 206 can instead be considered as causing or adding to internal clock delays for corresponding IPs 208, and therefore the minimum delay of each unit 206 should be included within the total internal clock delay for corresponding IP 208 when calculating the lower bounds on maximal programmable delays as described below.

2. Maximum (or maximal) programmable delay for unit 206—this parameter describes the maximum amount of clock delay that can be added by unit 206. If unit 206 is automatically pre-pended to corresponding IP 208 when IP 208 is developed, the lower bound on the decided upon maximum programmable delay needs to take into account possible uses of IP 208 within different SoCs.

In embodiments where unit 206 is pre-pended to corresponding IP 208 during the development of particular SoC 200, the lower bound on the decided upon maximum programmable delay can be more easily calculated. If unit 206 is expected to compensate for an internal clock delay in particular IP 208, then as a constraint, the lower bound (i.e. minimum) on the decided upon maximum programmable delay should substantially equal the minimum programmable delay for unit 206 plus the difference between the largest possible internal clock delay (of all IP cores 208) in SoC 200 and the internal clock delay of particular IP 208. If unit 206 for particular IP 208 is expected to compensate for external clock delays from the clock root to the input clock port of particular IP 208 then as a constraint, the lower bound on the maximum programmable delay should substantially equal the minimum programmable delay for unit 206 plus the difference between the largest external clock delay (from clock root to any IP core 208 clock input port in SoC 200) and the external clock delay from clock root to particular IP core 208. If unit 206 is expected to compensate for internal and external clock delays for particular IP 208, then as a constraint the lower bound on the maximum programmable delay should substantially equal the minimum programmable delay for unit 206 plus the difference between the largest external plus internal clock delay (of all IP cores 208) and the external plus internal clock delay of IP 208.

In certain embodiments of the invention, identical programmable units 206 are pre-pended to two or more IPs 208 within SoC 200, during the development of SoC 200. In these embodiments, the lower bound (i.e. minimum) on the decided upon maximum programmable delay is calculated as follows: If unit 206 is expected to compensate for internal clock delay in IPs 208, then as a constraint, the lower bound on the maximum programmable delay should substantially equal the minimum programmable delay for unit 206 plus the difference between the largest possible internal clock delay (of all IP cores 208) in SoC 200 and the smallest possible internal clock delay (of all IP cores 208). If unit 206 is expected to compensate for external clock delays from the clock root to the input clock port of IPs 208 then, as a constraint, the lower bound on the maximum programmable delay should substantially equal the minimum programmable delay for unit 206 plus the difference between the largest external clock delay (from clock root to any IP core 208 clock input port in SoC 200) and the smallest external clock delay (from clock root to any IP core 208 clock input port). If unit 206 is expected to compensate for internal and external clock delays for IP 208, then, as a constraint, the lower bound on the maximum programmable delay should substantially equal the minimum programmable delay for unit 206 plus the difference between the largest external plus internal clock delay (of all IP cores 208) and the smallest external plus internal clock delay (of all IP cores 208).

The maximum programmable delay can of course be higher than the lower bounds set forward above, and different units 206 pre-pended to different IPs 208 may have different maximum programmable delays even if the necessary (constrained) lower bounds are identical.

In a preferred embodiment of the invention, the decided upon maximum programmable delay is at least adjusted upwards from the lower bound to allow for future changes in external and/or internal delays within SoC 200 and other considerations. In other words a margin for future changes and other considerations is included.

2. Programmable delay unit 206 may allow an unlimited (analog) range of delays (between the minimum and maximum programmable delays) or may allow stepwise programmable delay values (between the minimum and maximum programmable delays).

In embodiments where stepwise programmable delay values are inserted by delay unit 206, an additional parameter is decided upon:

3. Delay resolution (d)—the difference between two successive programmable delay values. In embodiments where unit 206 is pre-pended to IP 208 during the development of particular SoC 200, the delay resolution is chosen be less than or substantially equal to twice the allowable clock skew (fixed deviation from proper clock phase) of SoC 200, (i.e. twice the allowable clock skew places a constraint on the maximum delay resolution to be chosen). In embodiments where delay unit 206 is automatically pre-pended to corresponding IP 208 when IP 208 is developed, without a particular SoC in mind, the chosen delay resolution should take into account the possible allowable clock skew of SoCs in which IP 208 is likely to be included.

In all chips (including SoCs), there are certain parameters which determine the needed accuracy of clock distribution, with the most important parameter often being the frequency of the chip. It should be evident that allowable clock skew, and therefore the delay resolution vary depending on the needed accuracy of clock distribution. Actual clock skew can be calculated, for example, by checking the difference in arrival time of the clock signals to memory elements within IPs 208 and subtracting the shortest arrival time from the largest arrival time.

In certain embodiments, the delay resolution of unit 206 pre-pended to particular IP 208 may differ from the delay resolution of another unit 206 pre-pended to another IP 208, even though both IPs 208 are included in the same SoC 200. An example of an application of these embodiments is if the allowable clock skews for one or more IP 208 differ according to IP provider requirements. Alternatively, twice the most demanding clock skew may be used as a constraint in selecting the delay resolution for all units 206.

Once unit 206 is pre-pended to IP 208, the next step of programming the inserted delay may follow immediately or much later. It should be evident that in embodiments where unit 206 is automatically pre-pended to corresponding IP 208 during the development of IP 208, the wait until the next step of programming is more likely to be longer than in embodiments where unit 206 is pre-pended to corresponding IP 208 during the development of specific SoC 200.

Programming the inserted delay for each IP 208 by each unit 206 and verifying SoC 200 for clock timing verification is the only iterative stage for aligning the clock of SoC 208. In one embodiment of the current invention, the programmed inserted delays are calculated as follows. If unit 206 compensates for differing internal clock delays (which may include differing minimum delays contributed by units 206 themselves as explained above) then the programmed inserted delay for each IP 208 substantially equals the minimum programmable delay for unit 206 plus the difference between the maximum internal clock delay among all IP cores 208 and the internal clock delay for the particular IP 208, rounded to the nearest programmable delay value. If unit 206 compensates for differing external clock delays (which may include differing minimum delays contributed by units 206 themselves as explained above) then the programmed inserted delay for each IP 208 substantially equals the minimum programmable delay for unit 206 plus the difference between the maximum external clock delay among all IP cores 208 and the external clock delay for the particular IP 208, rounded to the nearest programmable delay value. If unit 206 compensates for both differing internal and external clock delays (which may include minimum programmable delays contributed by units 206 themselves as explained above) then the programmed inserted delay for each IP 208 substantially equals the minimum programmable delay for unit 206 plus the difference between the maximum external and internal clock delay among all IP cores 208 and the external and internal clock delay for the particular IP 208, rounded to the nearest programmable delay value. The programming of the delays can be carried out during the final design stages, allowing quick integration of IP cores 208 into SoC 200.

In other embodiments of the current invention, the programmed inserted delay for each IP 208 is adjusted upwards or downwards by the same amount so that the relationship between the programmed inserted delays for each IP 208 is retained even though the absolute programmed inserted delays are adjusted.

If any of the clock delays for any IP 208 needs to be changed, due to changes in any IP 208, unit 206 for the corresponding IP 208 is reprogrammed and timing verification is repeated. Changes are possible at any stage of the design and a quick verification is always possible. The complete design flow becomes more flexible and last moment changes are enabled. The burden of timing verification is reduced.

Only in the case where particular IP 208 with the maximum internal and/or external clock delay among all IPs 208 is changed, do all units 206 in SoC 200 need to be reprogrammed. Even in this case, reprogramming is simple and quick verification is possible.

Using programmable clock delays eliminates the need to repeat, whenever any of IP cores 208 is changed, the three stages of global redesign presented above (i.e. adding delay elements, model extraction, and timing verification) for clock distribution network 204.

Using unit 206 allows changes in the programming of the delay for any IP 208 without changing the physical design of clock distribution network 204 of SoC 200. Therefore no back propagation occurs when realigning the clock, and expensive and time-consuming clock redesign iterations are avoided.

A particular embodiment of unit 206 using a clock tuning unit 207 with stepwise programmable delays will now be described. In certain embodiments, clock tuning unit 207 is a static clock tuning unit.

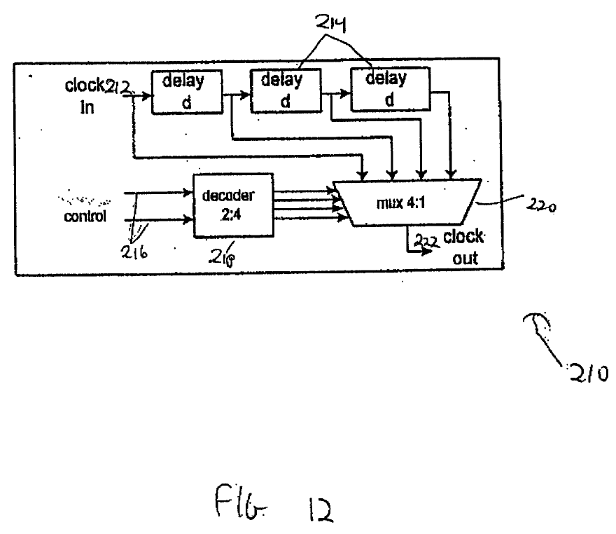

An example of a basic unit 210 of clock tuning unit 207 with a clock input 212 and a clock output 222 is shown in FIG. 12. In one embodiment, basic unit 210 is a digital controlled tapped delay line. The structure of unit 210 is determined by the needed delay resolution d of SoC 200. The delay resolution d can be changed by adding or subtracting buffers included in each delay cell 214.

The total delay of basic unit 210 can be changed (programmed) according to the number of the delay cells 214 that are enabled using control lines 216, a decoder 218 and a multiplexer 220. It should be evident that the embodiment of control lines 216, decoder 218 and multiplexer 220 is an example of a delay control that can be used to selectively enable delay cells 214, and other delay controls are within the scope of the invention. The number of delay combinations is 2^{m} for m control bits (in FIG. 12, m is assumed to be 2). Although three delay cells 214 are shown in FIG. 12, it should be evident that less or more delay cells 214 are within the scope of the invention, with the number of control lines 216 (control bits) dependent on the number of delay cells 214.

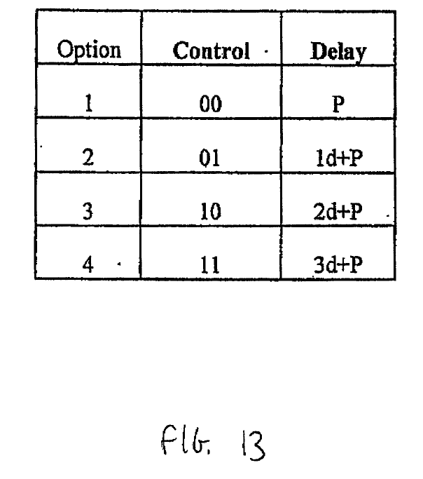

The timing behavior of unit 210 for m=2 is described in FIG. 13. P is the parasitic delay caused to the clock signal because of capacitance and resistance of the structure of unit 210 and not because of delay cells 214. Note from the first row of FIG. 13 that even when no delay cells 214 are enabled, the clock delay is not zero but equals the parasitic delay. Parasitic delays are determined after the layout (physical design of transistors) of the circuit of unit 210 is designed. From there, parasitic delays of connectivity are extracted.

In addition, in certain embodiments, default buffers drive signals, causing or adding to the clock delay even when no delay cells 214 are enabled. As mentioned above parasitic and/or default buffers contribute to the lower bound on the minimum programmable delay.

In certain embodiments of the invention, one unit 210 is included in tuning unit 207. In other embodiments, according to the maximal needed delay, it is decided how many basic units 210 need to be concatenated into each tuning unit 207 and what the parameters for each basic unit 210 needs to be. In a preferred embodiment of the present invention, each basic unit 210 that is concatenated into tuning unit 207 has different parameters dᵢ (delay resolution) and/or p₁ (parasitic delay). Use of concatenated tuning unit 207 which is built from two or more basic units 210 with different delay resolutions dᵢ, improves the range of the delay of tuning unit 207 compared to one larger basic unit 210 with a single delay resolution d (assuming the same number of delay cells 214 included in larger basic unit 210 as in the two or more basic units 210, combined, that are concatenated together) The smallest d₁ (i.e. min(dᵢ)) of all concatenated basic units 210 determines the delay resolution of complete unit 207. In the worst case, min(dᵢ) is equal to twice the clock skew. If the number of delay cells 214 in particular unit 210 is equal to k and particular unit 210 has delay resolution dₚ, then for optimality, the delay resolution closest in size but larger than dₚ corresponding to another basic unit 210 should be at least equal to the product of k and dₚ.

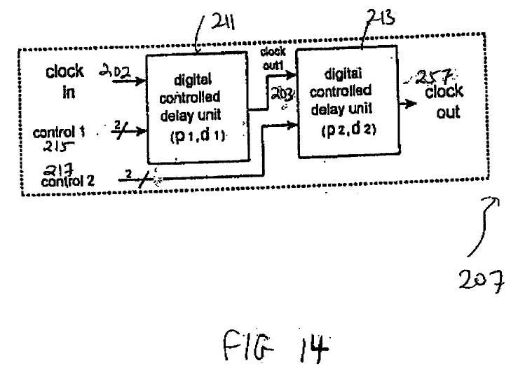

FIG. 14 illustrates an example of concatenating n=2 basic delay units 210 (of m=2) to form tuning unit 207 with d₁ and p₁ parameters characterizing one of basic units 210, namely a first basic unit 211, and d₂ and p₂ parameters characterizing another basic unit 210, namely a second basic unit 213. Clocks 212 and 222 of FIG. 12 are shown as clocks 202 and 203 for first basic unit 211 and as clocks 203 and 257 for second basic unit 213. The two units 211 and 213 are concatenated one after the other to enable 16 (2^{m+n}) delay combinations. It should be evident that a larger number of basic units 210 can be concatenated to form tuning unit 207.

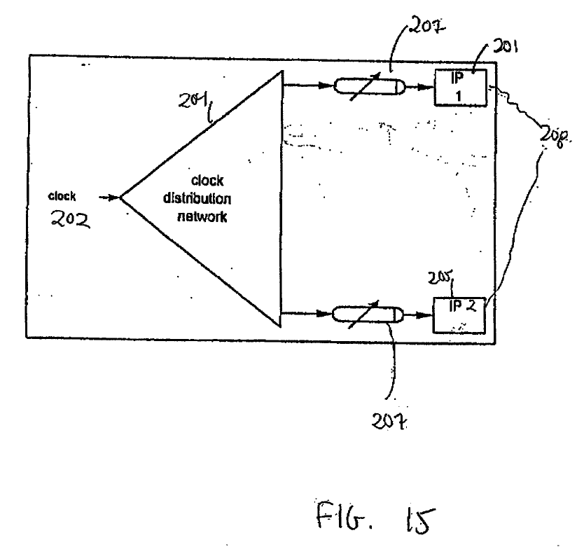

A non-limiting example of the usage of tuning unit 207 is illustrated in FIG. 15. Assume two IPs 208, IP1 201 having an internal clock delay of 0.3 ns and IP2 205 having an internal clock delay of 1.2 ns. Because of parasitic and other default delays due to tuning units 207 pre-pended to both IP1 201 and IP2 205, the minimum programmable delay is selected to be 0.4 ns for units 207 pre-pended to IP1 201 and IP2 205. The 0.4 ns delay of tuning units 207 is assumed to be the only contribution to the external delay of IP1 201 and IP2 205. Total internal and external delays for IP1 201 and IP2 205 are therefore 0.7 (0.3+0.4) and 1.6 (1.2+0.4) ns respectively. The maximal programmable delay of particular tuning unit 207 pre-pended to IP1 201 during the development of an SoC 209 must be at least 1.3 ns (i.e. minimum programmable delay of unit 207 plus maximum internal and external delay of any IP 208 less internal and external delay of IP1 201) and the maximal programmable delay of another particular tuning unit 207 pre-pended to IP2 205 during the development of SoC 209 must be at least 0.4 (i.e. minimum programmable delay of unit 207 plus maximum internal and external delay of any IP 208 less internal and external delay of IP2 205) to compensate for the differing clock delays. Assume however, that it is decided to use the same tuning unit 207 in front of each of IP1 201 and IP2 205, therefore the maximal programmable delay of each unit 207 must be at least 1.3 ns (i.e. minimum programmable delay of unit 207 plus maximum internal and external delay of any IP 208 less minimum internal and external delay of any IP 208). To add a margin for future design and other considerations, the maximum programmable delay is selected to be 1.6 ns. It is also assumed that the allowable clock skew is 0.06 ns, and the delay resolution chosen is 0.1 ns (even though a delay resolution of 0.12 ns would suffice). So the range of delay added by designed tuning circuit 207 is between 0.4 ns and 1.6 ns with steps of 0.1 ns.

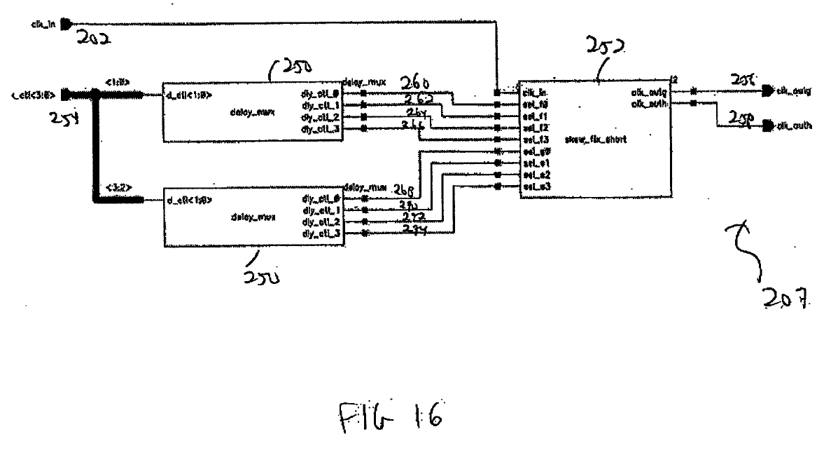

FIG. 16 shows an example of a circuit that can be used for tuning unit 207, with more details than the block diagram of FIG. 14. Tuning unit 207 includes two multiplexers 250 and a skew fixer 252. Clock 202 and control lines 254 are inputted into tuning unit 206 and clock 257 (separated in this embodiment into a clock_outg 256 and a clock_outh 258) are outputted from tuning unit 206. In this example, clk_outg 256 is used as a source to clock synthesis tool and clk_outh 258 is used as a source for any necessary hierarchical connection for hierarchical tuning.

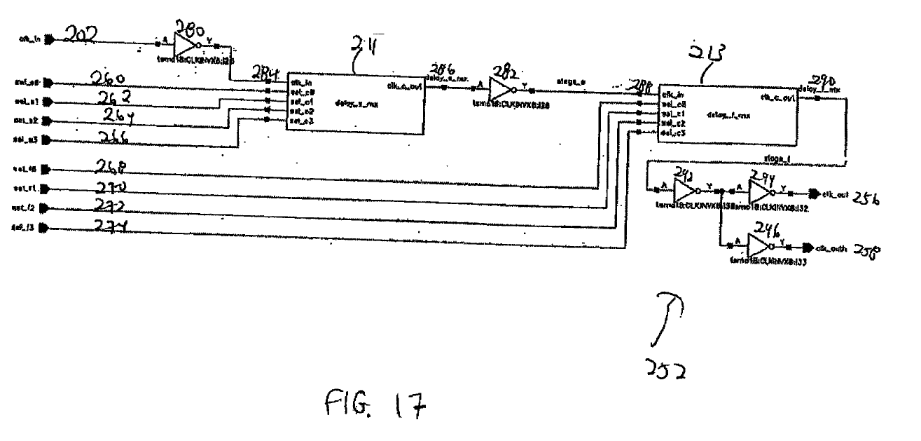

FIG. 17 shows an example of a circuit that can be used for skew fixer 252. Skew fixer 252 includes digital controlled delay units 211 and 213. Drivers (here, inverters) 280, 282, 292, 294 and 296 are located before unit 211, between units 211 and 213 and after unit 213 in order to supply the needed drive. Drivers 280, 282, 292, 294 and 296 also enable skew fixer 252 to have a fixed input capacitance and a fixed output drive.

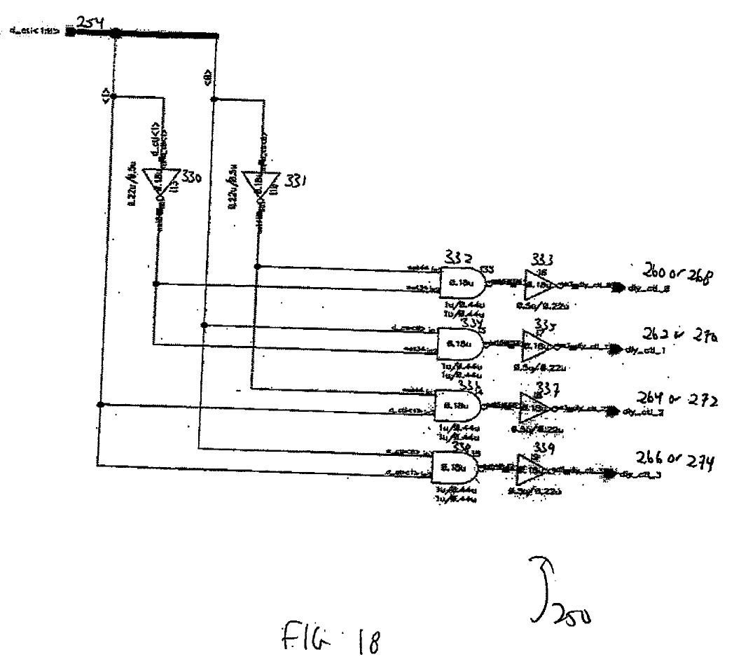

FIG. 18 shows an example of a circuit that can be used for each of multiplexers 250. In this example, multiplexers 250 are static multiplexers and can therefore be small in size.

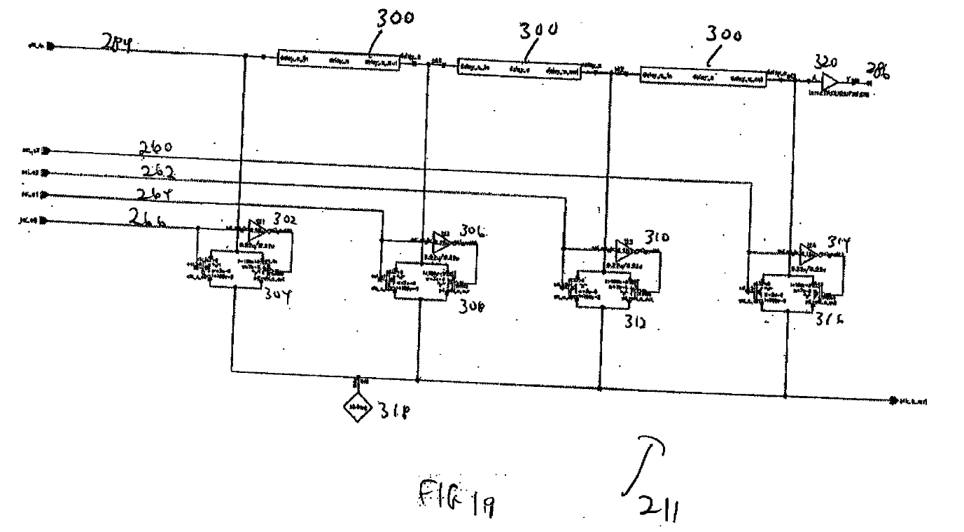

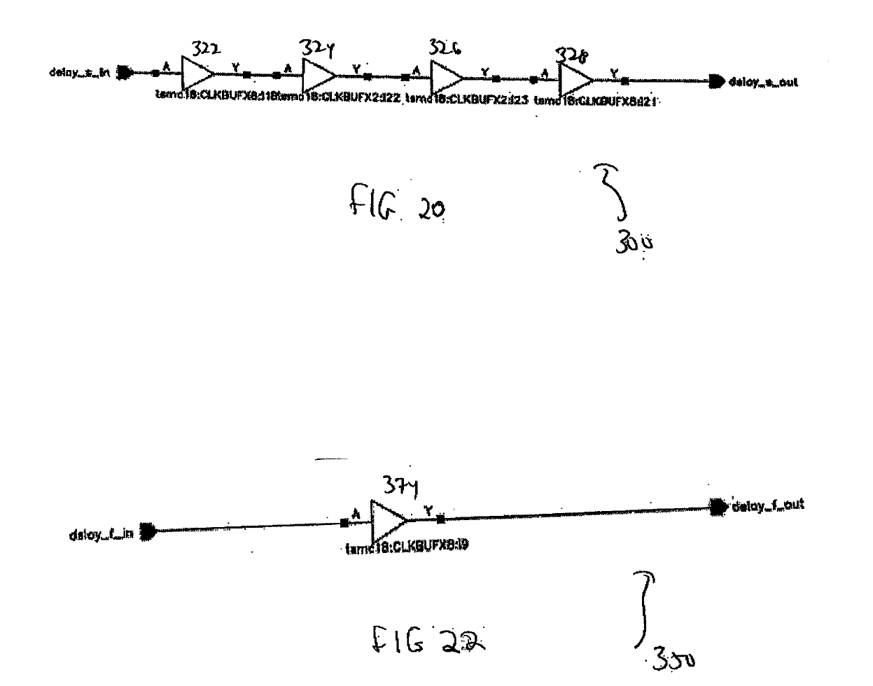

FIG. 19 shows an example of a circuit that can be used for first delay unit 211 in FIG. 17. Delay unit 211 includes three delay cells 300 (which are particular embodiments of delay cells 214). FIG. 20 shows an example of delay cell 300. Delay unit 211 also includes multiplexer logic, to choose among delay cells 300. In this example it is assumed that each delay cell 300 adds 0.3 ns delay (i.e. the delay resolution of delay unit 211 is 0.3 ns)

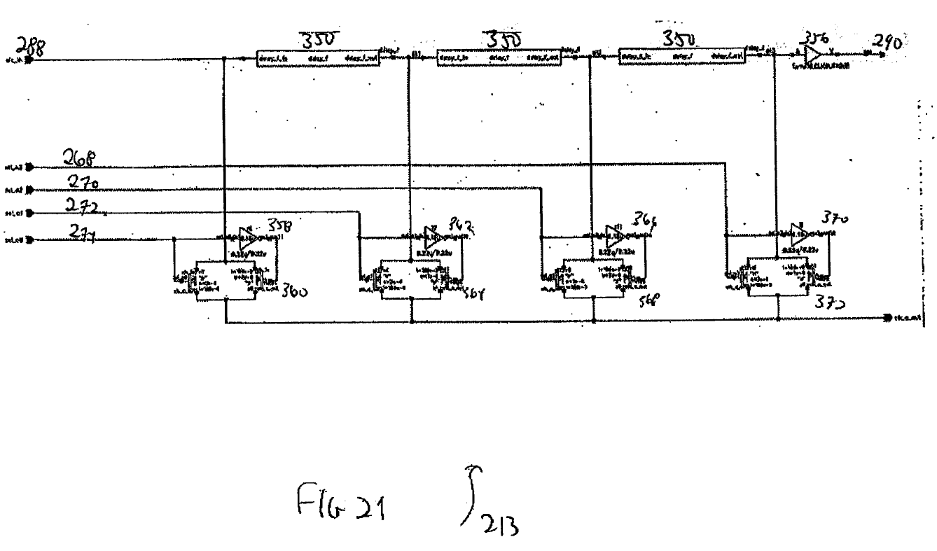

FIG. 21 shows an example of a circuit that can be used for second delay unit 213. Delay unit 213 includes three delay cells 350 (which are particular embodiment of delay cells 214). FIG. 22 shows an example of delay cell 350. In this example it is assumed that each delay cell 300 adds 0.1 ns delay (i.e. the delay resolution of delay unit 213 is 0.1 ns). Note that optimality is maintained because the delay resolution of delay unit 211 is at least equal to the product of delay resolution of unit 213 and the number of delay cells 350.

In order to program the needed delays, for unit 207 pre-pended to IP1 201, three delay cells 350 are enabled for an added delay of 0.9 ns (i.e. maximum internal and/or external delay of any IP 208 less internal and/or external delay of IP1 201, rounded to nearest delay value) to the minimum programmable value. For IP2 205, no delay cells are enabled for an added delay of 0. Note, however that the minimum delay (0.4 ns) of unit 207 causes the total inserted delay of IPs 201 and 205 to be 1.3 ns and 0.4 ns respectively.

In another embodiment of the present invention, in addition to or instead of programming the delays for IPs 208 at the final design stage, the delays for some or all of IPs 208 are programmed at testing time, right after fabrication. This method (“tester based tuning”) may compensate for die to die delay variation.

In another embodiment of the present invention, in addition to or instead of programming the delays for IPs 208 in the final design stage, delays for some or all of IPs 208 are programmed during power up of SoC 200. The method may compensate for delay variations, which result from varying environmental conditions such as temperature and voltage.

In another embodiment of the present invention, in addition to or instead of programming the delays of IPs 208 at the final design stage, delays for some or all of IPs 208 are adjusted dynamically (for example through PLLs), compensating for delay variations resulting from varying conditions, such as voltage and temperature during operations.

In another embodiment of the present invention, hierarchical tuning is performed, taking advantage of the hierarchical structure, if existent, of SoC 200. For example, it is assumed that SoC 200 comprises multiple subsystems, where each subsystem integrates multiple IP cores. Clock tuning is first applied to each subsystem, and the internal clock delay for each subsystem is determined. Next global clock tuning is applied to entire SoC 200. Afterwards, when the design of any one of the sub-systems change, only that subsystem and the global distribution network must be re-tuned, while the other subsystems remain unaffected. In this embodiment, there would be tuning circuits in front of one or more IP's within one or more subsystems as well as tuning circuits in front of one or more subsystems.

While the invention has been described with respect to a limited number of embodiments, it will be appreciated that many variations, modifications and other applications of the invention may be made.

What is claimed is:

1. A method for adding a clock delay to the clock input of a module, comprising the steps of:
deciding upon a minimum programmable clock delay for the module; and
pre-pending a clock delay unit with a programmable clock delay to the module, wherein said programmable clock delay is configured to range up from said minimum programmable clock delay.

2. The method of claim 1, further comprising the step of:
deciding upon a maximum programmable clock delay for the module;
wherein said programmable clock delay is configured to range from said minimum programmable clock delay up to said maximum programmable clock delay.

3. The method of claim 1, further comprising the step of:
deciding upon a clock delay resolution;
wherein said programmable clock delay is configured to increase in range by steps equivalent to said clock delay resolution.

4. The method of claim 1, further comprising the step of:
programming said programmable clock delay so as to give a desired programmed clock delay.

5. The method of claim 4, wherein the module is included in a chip with at least one other module and wherein there exists differing delays between the module and at least one of said other modules, said programming step including:
adjusting for differing delays between the module and at least one of said other modules.

6. The method of claim 5, wherein said adjusting step includes:
calculating a programmed clock delay, said calculated programmed clock delay substantially equaling said minimum programmable clock delay plus the maximum delay among all modules within said chip less a delay for the module.

7. The method of claim 6, wherein said programmable clock delay is configured to increase in steps, said adjusting step further including:
rounding said calculated programmed clock to the nearest programmable clock delay step.

8. The method of claim 5, wherein said differing delays include internal delays.

9. The method of claim 5, wherein said differing delays include external delays.

10. The method of claim 4, further comprising the step of:
repeating the step of programming as many times as required.

11. The method of claim 4, wherein said module is included in a chip and said programming step is carried out during the final design stages of said chip.

12. The method of claim 4, wherein said module is included in a chip and said programming step is carried out during power up of said chip.

13. The method of claim 4, wherein said programming step is carried out dynamically.

14. The method of claim 4, wherein the module is included in a chip with at least one other module, the module and said at least one other module forming at least two subsystems and said at least two subsystems forming a system, wherein said programming step includes:
programming said subsystems and said system hierarchically.

15. The method of claim 4, wherein the module is included in a chip, further comprising the step of:
verifying that said programmed clock delay meets a timing constraint of said chip.

16. A system for adding a clock delay to the clock input of a module, comprising:
a module; and
a programmable clock delay unit pre-pended to said module, configured to add a programmed clock delay.

17. The system of claim 16, wherein said module is included in a chip further comprising:
at least one other module within said chip;
wherein said programmed clock delay adjusts for differing delays between the module and said at least one other module.

18. The system of claim 17, further comprising:
at least one other programmable clock delay unit pre-pended to at least one of said modules.

19. The system of claim 18, wherein at least one of said other programmable clock delay units pre-pended to at least one of said other modules is identical to said programmable clock delay unit pre-pended to the module.

20. The system of claim 17, wherein said chip includes a system on a chip (SoC).

21. An apparatus for programming a clock delay, comprising:
at least one delay cell; and
a delay control for selectively enabling said at least one delay cell.

22. The apparatus of claim 21, wherein at least one of said delay cells includes at least one buffer.

23. The apparatus of claim 21, wherein at least one of said delay cells, when enabled, adds to a programmed clock delay by an amount substantially equivalent to a delay resolution of the apparatus.

24. The apparatus of claim 21, wherein a programmed clock delay, when none of said at least one delay cells is enabled includes a parasitic delay.

25. The apparatus of claim 21, wherein a programmed clock delay, when none of said at least one delay cells is enabled includes a delay due to at least one default buffer.

26. The apparatus of claim 21, wherein at least one of said delay cells, when enabled, adds to the programmed clock delay by an amount larger than a delay resolution of the apparatus.

27. The apparatus of claim 26, wherein said at least one delay cell includes at least two delay cells divided into at least two groups with differing delay resolutions, and the delay resolution of a group is at least substantially equal to the product of the next largest delay resolution and the number of delay cells within the group with the next largest delay resolution.

28. The apparatus of claim 21, wherein the apparatus is a digital controlled tapped delay line.

29. The apparatus of claim 21, wherein said delay control includes at least one control line and at least one multiplexer.

30. The apparatus of claim 21, wherein the apparatus is a static clock tuning unit.
